(19) United States
(12) Patent Application Publication
(10) Pub. No.: US 2017/0040609 A1
(43) Pub. Date: Feb. 9, 2017

(54) LITHIUM ION SECONDARY BATTERY

(71) Applicant: TOYOTA JIDOSHA KABUSHIKI KAISHA, Toyota-shi (JP)

(72) Inventor: Koji TAKAHATA, Nisshin-shi (JP)

(73) Assignee: TOYOTA JIDOSHA KABUSHIKI KAISHA, Toyota-shi (JP)

(21) Appl. No.: 15/226,094

(22) Filed: Aug. 2, 2016

(30) Foreign Application Priority Data
Aug. 5, 2015 (JP) 2015-155540

(51) Int. Cl. H01M 4/525; H01M 10/0587; H01M 4/131; H01M 10/0569; H01M 4/587; H01M 4/133; H01M 4/62; H01M 10/0568; H01M 10/0525; H01M 4/505

(52) U.S. Cl. CPC H01M 4/525; H01M 10/0525; H01M 10/0587; H01M 4/131; H01M 4/505; H01M 4/587; H01M 4/133; H01M 4/625; H01M 10/0568; H01M 10/0569; H01M 4/623; H01M 2220/20; H01M 2300/004

(57) ABSTRACT

Provided is a lithium ion secondary battery which is improved particularly in a low-temperature characteristic. The lithium ion secondary battery disclosed herein includes a ternary positive electrode active material formed of a lithium transition metal composite oxide having at least Ni, Co, and Mn, and a carbon-black-adhered carbon-based negative electrode active material which is formed of a carbon material having a graphite structure in at least part thereof and which has carbon black (CB) that has adhered to at least part of a surface portion. A molar ratio x of Ni calculated by taking a total molar amount of Ni, Co, and Mn in the ternary positive electrode active material as 100 satisfies the condition of 34≦x≦46, and a mass ratio a of carbon black calculated by taking a total mass of the carbon material and carbon black in the carbon-black-adhered carbon-based negative electrode active material as 100 satisfies the condition of 0.3≦α≦5.

### BACKGROUND OF THE INVENTION

1. Field of the Invention

The present invention relates to a lithium ion secondary battery, and more particularly to a positive electrode material and a negative electrode material for constituting a lithium ion secondary battery. The present application claims priority to Japanese Patent Application No. 2015-155540 filed on Aug. 5, 2015, the entire contents of which are hereby incorporated by reference.

2. Description of the Related Art

The so-called lithium ion secondary batteries, which are kinds of nonaqueous electrolyte secondary batteries and in which charge carriers are lithium ions, have been widely used as portable power sources for personal computers, portable terminals, and the like, and as drive power sources for vehicles. Since the lithium ion secondary batteries are lightweight and make it possible to obtain a high energy density, they are expected to be hereinafter increasingly popular, in particular, as high-output drive power sources for driving the vehicle motor to be installed on vehicles.

A low-temperature characteristic is one of the characteristics required for the lithium ion secondary batteries which are to be used as drive power sources for vehicles. Specifically, the batteries are required to be durable such that capacity degradation of the batteries is suppressed and the desired battery capacity can be maintained even in repeated charging and discharging in a temperature range below the freezing point (for example, at −10° C. or a lower temperature). Further, by contrast with the lithium ion secondary batteries for consumer applications, the lithium ion secondary batteries which are to be used as drive power sources for vehicles are also required to excel in the so-called high-rate characteristic (rapid charge-discharge characteristic) which enables high-current charging and discharging over a short period of time. Therefore, the improvement of low-temperature characteristic and high-rate characteristic will be also an important research topic in the field of lithium ion secondary batteries which are to be used as drive power sources for vehicles.

The low-temperature characteristic and high-rate characteristic of the lithium ion secondary batteries can be improved by modifying the properties, structure, and composition of positive electrode active material and/or negative electrode material which are used in the batteries.

For example, Japanese Patent Application Publication No. 2013-258392 discloses “an electrode active material formed of a carbon material characterized in that a fine pore diameter is 50 nm to 400 nm and a micropore volume is 0.05 cc/g to 0.40 cc/g”, the electrode active material being provided with the object of improving the low-temperature characteristic. Further, Japanese Patent Application Publication No. 2008-27664 discloses “a negative electrode active material for a lithium ion secondary battery which is formed of substantially spherical graphite particles having fine projections on the surface, the active material being manufactured by impregnating and coating a base material of spherical natural graphite with a mixture of pitch and carbon black and then calcining at 900° C. to 1500° C.” as a negative electrode active material that excels in cycle characteristic (durability) and high-rate characteristic.

### SUMMARY OF THE INVENTION

By using the active materials such as disclosed in the above-mentioned patent literatures, it is apparently possible to attain some improvement in battery characteristics such as low-temperature characteristic of a lithium ion secondary battery, but there is still room for improvement.

The present invention has been created to further improve battery characteristics in lithium ion secondary batteries which are mainly to be used as drive power sources for vehicles on the basis of contents and approach which are different from those disclosed in the above-mentioned patent literatures, and it is an objective of the present invention to provide a lithium ion secondary battery which is improved particularly in a low-temperature characteristic.

The lithium ion secondary battery provided by the present invention to attain the objective includes a positive electrode, a negative electrode, and a nonaqueous electrolytic solution, wherein

the positive electrode includes a ternary positive electrode active material formed of a lithium transition metal composite oxide having at least nickel (Ni), cobalt (Co), and manganese (Mn); and

the negative electrode includes a carbon-black-adhered carbon-based negative electrode active material which is formed of a carbon material having a graphite structure in at least part thereof and which has carbon black (CB) that has adhered to at least part of a surface portion.

A molar ratio x of nickel (Ni) calculated by taking a total molar amount of nickel (Ni), cobalt (Co), and manganese (Mn) in the ternary positive electrode active material as 100 (that is, x can be also represented in mol % as (Ni/(Ni+Co+Mn)×100)) satisfies the following condition:

34≦x≦46.

A mass ratio a of carbon black (CB) calculated by taking a total mass of the carbon material and carbon black in the carbon-black-adhered carbon-based negative electrode active material as 100 (that is, a can be also represented by mass % as (CB/(carbon material+CB)×100)) satisfies the following condition:

0.3≦α≦5.

The inventor has discovered that when a ternary positive electrode active material formed of the lithium transition metal composite oxide (can be also referred to hereinbelow as “NCM lithium composite oxide”) which is known to have the so-called layered rock-salt type crystal structure is used as a positive electrode active material, and a carbon-black-adhered carbon-based negative electrode active material which is formed of a carbon material having a graphite structure in at least part thereof (can be also referred to hereinbelow as “graphite-based carbon material”) and which has carbon black (CB) that has adhered to at least part of a surface portion is used as a negative electrode active material, the low-temperature characteristic of a lithium ion secondary battery can be advantageously improved by adjusting the x and a to predetermined ranges. This finding led to the creation of the present invention.

Thus, with the configuration of the lithium ion secondary battery disclosed herein, it is possible to improve the low-temperature characteristic, that is, to improve a capacity retention ratio when the battery is used under a low-temperature environment such that input and output are repeated at a temperature equal to or lower than 0° C. (for example, within a low-temperature range from −10° C. to −20° C.).

In the preferred aspect of the lithium ion secondary battery disclosed herein, the molar ratio x of nickel (Ni) calculated by taking a total molar amount of nickel (Ni), cobalt (Co), and manganese (Mn) in the ternary positive electrode active material as 100 satisfies the condition of 36≦x≦42, and the mass ratio a of carbon black (CB) calculated by taking a total mass of the carbon material and carbon black in the carbon-black-adhered carbon-based negative electrode active material as 100 satisfies the condition of 0.3≦α≦3.

With such features, in addition to the improvement of the low-temperature characteristic, it is also possible to improve the high-rate characteristic, for example, to reduce the internal resistance increase ratio in repeated high-rate charging, for example, at a rate of 10 C (inclusive) to 30 C (inclusive) in a normal temperature range (10° C. to 35° C., for example, about 25° C.).

In another preferred aspect of the lithium ion secondary battery disclosed herein, the NCM lithium composite oxide is a compound represented by the following formula:

Li₁₊ₐ(NiₓCo_{y}Mn_{z})_{1-γ}M_{γ}O₂

(where 0≦a≦0.14, x+y+z=1, 0.34≦x≦0.46, 0.99≦y/z≦1.01, 0≦γ≦0.05, and M is at least one element selected from the group consisting of Zr, W, Nb, Mg, Ca, Na, Fe, Cr, Zn, Si, Sn, Al, B, and F).

As a result of using the NCM lithium composite oxide having a composition in which the Ni content is larger than that of Co and Mn (Ni-rich composition) and the contents of Co and Mn are substantially equal to each other, as indicated by the formula above, the low-temperature characteristic and high-rate characteristic can be improved more advantageously.

### BRIEF DESCRIPTION OF THE DRAWINGS

FIG. 1 illustrates schematically the internal configuration of the lithium ion secondary battery according to an embodiment;

FIG. 2 is a graph illustrating the results obtained in comparing the capacity retention ratio after a charge-discharge cycle (300 cycles) test under a low-temperature environment at −10° C. among a plurality of sample batteries that differ in the Ni amount in the positive electrode active material and the adhered amount of acetylene black in the negative electrode active material; and

FIG. 3 is a graph illustrating the results obtained in comparing the resistance increase ratio after a charge-discharge cycle (4000 cycles) test involving high-rate charging under a normal-temperature environment at 25° C. among a plurality of sample batteries that differ in the Ni amount in the positive electrode active material and the adhered amount of acetylene black in the negative electrode active material.

### DESCRIPTION OF THE PREFERRED EMBODIMENTS

The preferred embodiment of the lithium ion secondary battery disclosed herein will be explained hereinbelow. It should be noted that matters necessary for carrying out the present invention other than those specifically referred to in the description are understood to be matters of design for a person skilled in the art which are based on the related art in the pertinent field. The present invention can be implemented on the contents disclosed in the present specification and common technical knowledge in the pertinent field. The preferred embodiment of the present invention will be explained hereinbelow by considering a lithium ion secondary battery in which a flat wound electrode body and a nonaqueous electrolytic solution are housed in a case of a corresponding flat shape (box-like shape).

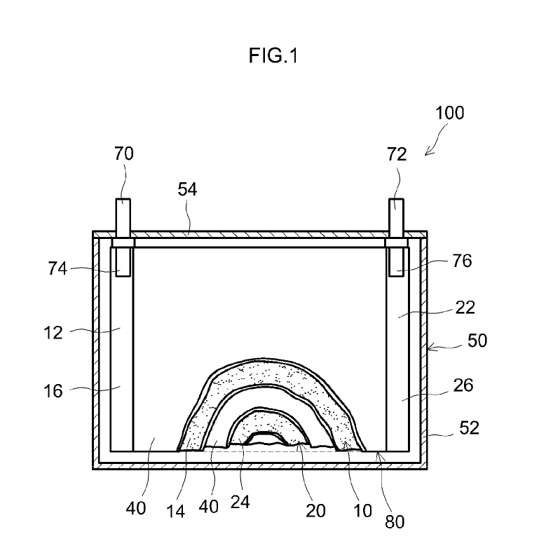

As depicted in FIG. 1, the lithium ion secondary battery 100 according to the present embodiment has a case 50 made of a metal (a resin or a laminated film can be also advantageously used). The case (outer case) 50 has a case main body 52 of a flat rectangular parallelepiped shape with an open upper end and a lid 54 that closes the opening.

A positive electrode terminal 70 electrically connected to a positive electrode 10 of a wound electrode body 80, and a negative electrode terminal 72 electrically connected to a negative electrode 20 are provided at the upper surface (that is, the lid 54) of the case 50. A flat-shaped wound electrode body 80, which is obtained by laminating the positive electrode (positive electrode sheet) 10 of an elongated sheet shape, the negative electrode (negative electrode sheet) 20 of an elongated sheet shape and a total of two separators (separator sheets) 40 of an elongated sheet shape and winding the laminate, and the nonaqueous electrolytic solution are housed inside the case 50.

A gas release mechanism such as a safety valve for releasing the gas generated inside the case 50 to the outside of the case 50 is provided at the lid 54 in the same manner as in the conventional lithium ion secondary batteries of this type, but since this mechanism is not a specific feature of the present invention, the explanation thereof and illustration in the drawings is herein omitted.

In the positive electrode sheet 10, a positive electrode active material layer 14 including a positive electrode active material (NCM lithium composite oxide) as the main component is provided on both surfaces of a positive electrode collector 12 of an elongated sheet shape. However, the positive electrode active material layer 14 is not provided on one side edge (end portion on one side in the winding axis direction) in the width direction which is perpendicular to the longitudinal direction of the positive electrode sheet 10, and thereby a positive electrode active material layer non-formation portion 16 is provided in which the positive electrode collector 12 is exposed over a predetermined width.

In the lithium ion secondary battery disclosed herein, the positive electrode active material is formed of the above-described ternary positive electrode active material, that is, a NCM lithium composite oxide.

More specifically, a NCM lithium composite oxide is used which is prepared such that a molar ratio x of Ni calculated by taking a total molar amount of Ni, Co, and Mn as 100 is 34≦x≦46 (that is, where the total of Ni, Co, and Mn is taken as 100 mol %, the molar ratio of Ni is 34 mol % (inclusive) to 46 mol % (inclusive)). By using the positive electrode active material formed of such Ni-rich NCM lithium composite oxide, it is possible to improve the low-temperature characteristic of the lithium ion secondary battery.

By using the positive electrode active material formed of the NCM lithium composite oxide prepared such that the Ni molar ratio x is 36≦x≦42 (that is, the molar ratio of Ni is 36 mol % (inclusive) to 42 mol % (inclusive)), it is possible to improve not only the low-temperature characteristic, but also the high-rate characteristic.

The preferred example of such Ni-rich NCM lithium composite oxide is a compound represented by the following formula:

Li₁₊ₐ(NiₓCo_{y}Mn_{z})_{1-γ}M_{γ}O₂

Here, a, x, y, z, and y in the formula are numerical values satisfying the following conditions. Thus,

0≦a≦0.14,

x+y+z=1,

0.34≦x≦0.46 (more preferably, 0.36≦x≦0.42),

0.99≦y/z≦1.01 (more preferably, y=z, that is, y/z=1), and

0≦γ≦0.05.

The element [M] in the formula is at least one element selected from the group consisting of W, Zr, Nb, Mg, Ca, Na, Fe, Cr, Zn, Si, Sn, Al, B, and F. For example, it is preferred that W and/or Zr be included. The content of M is not particularly limited, provided that the functions of the positive electrode active material of the lithium ion secondary battery are not inhibited, and where the total of Ni, Co, Mn, and M is taken as 100 mol %, the content of M is appropriately 5 mol % or less, typically, 2 mol % or less, for example, 0.01 mol % (inclusive) to 2 mol % (inclusive), and preferably 0.05 mol % (inclusive) to 1 mol % (inclusive).

By including Zr in such an amount, it is possible to avoid the decrease in the peel strength between the positive electrode active material layer and positive electrode collector which is caused by migration of a binder in the positive electrode active material layer.

Further, it is preferred that W be included in such an amount because the reaction resistance of the battery can be further reduced.

As a result of using the Ni-rich NCM lithium composite oxide in which y and z in the formula satisfy the condition 0.99≦y/z≦1.01, that is, the molar ratio of Co and Mn are substantially the same, the low-temperature characteristic and high-rate characteristic can be further advantageously improved.

A positive electrode active material formed of such Ni-rich NCM lithium composite oxide can be manufactured by the conventional method. For example, the manufacturing method can include the steps of preparing an aqueous solution including a nickel salt, a cobalt salt, and a manganese salt (examples of salts of such transition metals include sulfates, nitrates, and chlorides) at a predetermined molar ratio, neutralizing the aqueous solution by adding a basic aqueous solution (ammonia water, or the like), while controlling the pH, to precipitate a NCM composite hydroxide, mixing the NCM composite hydroxide with a lithium salt (for example, lithium carbonate and lithium hydroxide), adding a compound of the desired element M (for example, zirconium oxide and tungsten oxide), mixing, and calcining.

A positive electrode active material of the so-called hollow structure (hollow particles) having a shell and a hollow portion formed inside thereof, or a positive electrode active material of the so-called solid structure (solid particles) having no hollow portion are suitable as the positive electrode active material (particles) which is to be used. The positive electrode active material particles of the hollow structure are preferred because the matter exchange with the nonaqueous electrolytic solution (for example, migration of Li ions) can be performed more effectively than in the case of positive electrode active material particles of the solid structure.

By pulverizing, grinding, sieving, and classifying the ternary positive electrode active material formed of the Ni-rich NCM lithium composite oxide obtained in the above-described manner, as necessary, the particle size thereof can be adjusted to the desired particle size.

The preferred average particle size of the positive electrode active material particles (secondary particles) disclosed herein is generally 1 μm (inclusive) to 25 μm (inclusive). With the positive electrode active material particles of such an average particle size, good battery performance can be demonstrated with better stability. In the preferred embodiment, the average particle size of the positive electrode active material particles is about 3 μm (inclusive) to 10 μm (inclusive). The average particle size of the positive electrode active material particles can be determined by a method well known in the pertinent field, for example, by measurements based on a laser diffraction and scattering method. The abovementioned average particle size is based on the measurements conducted by the laser diffraction and scattering method.

The positive electrode active material layer 14 can be formed by mixing the above-described positive electrode active material (NCM lithium composite oxide) with a variety of additives to prepare a composition and applying the prepared composition (for example, a slurry-like composition prepared by adding a nonaqueous solvent, or a granulated material obtained by granulating the positive electrode active material together with the additives) to the positive electrode collector 12 to obtain a predetermined thickness.

An electrically conductive material is an example of the additive. A carbon material such as a carbon powder and carbon fibers is preferably used as the electrically conductive materials. Examples of other additives include various polymer materials capable of functioning as binders. For example, polymers such as polyvinylidene fluoride (PVDF) and polyvinylidene chloride (PVDC) can be advantageously used. Alternatively, a styrene-butadiene rubber (SBR), polytetrafluoroethylene (PTFE), polyethylene (PE), and polyacrylic acid (PAA) may be used.

Similarly to the positive electrode sheet 10, the negative electrode sheet 20 also has the configuration in which the negative electrode active material layer 24 including a negative electrode active material (carbon-black-adhered carbon-based negative electrode active material) as the main component is provided on both surfaces of an elongated negative electrode collector. However, the negative electrode active material 24 is not provided on one side edge in the width direction of the negative electrode sheet 20 (that is, the end at one side in the winding axis direction, this end being opposite that of the positive electrode active material layer non-formation portion 16), and thereby a negative electrode active material layer non-formation portion 26 is formed in which the negative electrode collector 22 is exposed over a predetermined width.

In the lithium ion secondary battery disclosed herein, the above-described carbon-black-adhered carbon-based negative electrode active material, that is, the carbon-black-adhered carbon-based negative electrode active material in which carbon black (CB) has adhered to at least part of the surface portion of the graphite-based carbon material having a graphite structure in at least part thereof, is used as the negative electrode active material.

More specifically, the carbon-black-adhered carbon-based negative electrode active material is used which is prepared such that the mass ratio a of CB is 0.3≦α≦5 when the total mass of the graphite-based carbon material and CB is taken as 100 (that is, the CB content is 0.3 mass % (inclusive) to 5 mass % (inclusive) when the total of the graphite-based carbon material and carbon black (CB) is taken as 100 mass %).

As a result of using the carbon-black-adhered carbon-based negative electrode active material with such a CB content in combination with the positive electrode active material formed of the above-described Ni-rich NCM lithium composite oxide, it is possible to improve further the low-temperature characteristic of the lithium ion secondary battery.

As a result of using the carbon-black-adhered carbon-based negative electrode active material prepared such that the mass ratio a of CB is 0.3≦α≦3 (that is, the CB content is 0.3 mass % (inclusive) to 3 mass % (inclusive)) in combination with the positive electrode active material formed of the above-described Ni-rich NCM lithium composite oxide, it is possible to improve not only the low-temperature characteristic, but also the high-rate characteristic.

Various graphite materials, such as natural graphite and artificial graphite, which have been formed into spheres or flakes can be used as the graphite-based carbon material advantageous for manufacturing the carbon-black-adhered carbon-based negative electrode active material with such CB content.

Alternatively, a graphite-based carbon material in which the surface of graphite particles is coated with amorphous carbon can be advantageously used.

A CB which is caused to adhere to at least part of the surface portion (in the graphite-based carbon material with the amorphous carbon coating, the surface portion is inclusive of the coat layer of the amorphous carbon which is present on the surface of the graphite-based carbon material) of such graphite-based carbon material is not limited to any specific type, and a typical carbon black such as acetylene black (AB), Ketjen black, and furnace black can be used without any limitation.

A method for causing the CB to adhere to the surface portion of the graphite-based carbon material is not particularly limited. For example, the preparation method can be used by which particles formed of the graphite-based carbon material, a material (pitch, or the like) for forming the amorphous coat layer on the surface of the particles, and CB particles are kneaded, and then calcined in a high-temperature range (for example, 500° C. (inclusive) to 1500° C. (inclusive)).

Particles of the carbon-black-adhered carbon-based negative electrode active material obtained by the calcination can be cooled and then ground by milling, etc., as necessary to adjust the particle size thereof as appropriate. An appropriate binder may be introduced in the mixture of the carbon particles and CB particles in order to increase the adhesion between the CB particles and the particles formed of the graphite-based carbon material in the process of supporting the CB particles on the surface of the particles formed of the graphite-based carbon material.

The size of the carbon-black-adhered carbon-based negative electrode active material which has been thus obtained is not particularly limited, but it is preferred that a material be used which has an average particles size of, for example, 1 μm (inclusive) to 50 μm (inclusive) (typically, 5 μm (inclusive) to 20 μm (inclusive), preferably 8 μm (inclusive) to 12 μm (inclusive)) based on the laser diffraction and scattering method.

The negative electrode active material layer 24 can be formed by mixing the above-described negative electrode active material (carbon-black-adhered carbon-based negative electrode active material) with a variety of additives to prepare a composition and applying the prepared composition (for example, a slurry-like composition prepared by adding an aqueous solvent or a nonaqueous solvent, or a granulated material obtained by granulating the positive electrode active material together with the additives) to the negative electrode collector to obtain a predetermined thickness.

A binder is an example of the additive. For example, the binder of the same type as included in the above-described positive electrode active material layer 14 can be used. A thickening agent and a dispersant can be used, as appropriate, as other additives. For example, carboxymethyl cellulose (CMC) or methyl cellulose (MC) can be advantageously used as the thickening agent.

The separator 40 that is laminated together with the positive electrode sheet 10 on which the positive electrode active material layer 14 has been formed and the negative electrode sheet 20 on which the negative electrode active material layer 24 has been formed is a member separating the positive electrode sheet 10 and the negative electrode sheet 20 from each other.

The separator 40 is typically formed of a strip-shaped sheet material of a predetermined width which has a plurality of fine holes. For example, a separator of a monolayer structure or a separator of a multilayer structure formed of a porous polyolefin resin can be used as the separator 40. A layer of electrically insulating particles may be further formed on the surface of the sheet material formed of such a resin. The electrically insulating particles may be in the form of an electrically insulating inorganic filler (for example, a filler formed of a metal oxide or metal hydroxide), or electrically insulating resin particles (for example, particles of polyethylene or polypropylene).

During the lamination, the positive electrode sheet 10 and the negative electrode sheet 20 are placed on each other with a slight displacement in the width direction such that the positive electrode active material layer non-formation portion 16 of the positive electrode sheet 10 and the negative electrode active material layer non-formation portion 26 of the negative electrode 20 protrude from both sides, in the width direction, of the separator 40. As a result, the active material layer non-formation portions 16, 26 of the positive electrode sheet 10 and the negative electrode sheet 20 protrude outward from the respective winding core portions (that is, portions in which the positive electrode active material layer formation portion of the positive electrode sheet 10, the negative electrode active material layer formation portion of the negative electrode sheet 20, and the two separator sheets 40 are tightly wound) in the transverse direction with respect to the winding direction of the wound electrode body 80. A positive electrode lead terminal 74 and a negative electrode lead terminal 76 are provided at the protruding portion of the positive electrode side (that is, the positive electrode active material layer non-formation portion) 16 and the protruding portion of the negative electrode side (that is, the negative electrode active material layer non-formation portion) 26, respectively, and electrically connected to the positive electrode terminal 70 and the negative electrode terminal 72, respectively.

Solutions same as the nonaqueous electrolytic solutions which have been conventionally used in the lithium ion secondary batteries can be used as the electrolytic solution (nonaqueous electrolytic solution) without any limitation. Such a nonaqueous electrolytic solution typically has a composition including a support salt in an appropriate nonaqueous solvent. Examples of the nonaqueous solvents include ethylene carbonate, propylene carbonate, dimethyl carbonate, diethyl carbonate, ethylmethyl carbonate, 1,2-dimethoxyethane, 1,2-diethoxyethane, tetrahydrofuran, and 1,3-dioxolane. Such nonaqueous solvents can be used individually or in combinations of one or two or more thereof. Examples of suitable support salts include lithium salts such as LiPF₆, LiBF₄, LiAsF₆, LiCF₃SO₃, LiC₄F₉AO₃, LiN(CF₃SO₂)₂, and LiC(CF₃SO₂)₃. For example, a nonaqueous electrolytic solution can be used in which LiPF₆ is contained at a concentration of about 1 mol/L in a mixed solvent of ethylene carbonate (EC), dimethyl carbonate (DMC), and ethylmethyl carbonate (EMC) (for example, at a volume ratio of 3:4:3).

When the lithium ion secondary battery is assembled, the wound electrode body 80 is housed inside the case main body 52 through the upper end opening of the main body 52 and the appropriate nonaqueous electrolytic solution is also disposed (poured) in the case main body 52. Then, the opening is sealed with the lid 54 by welding, etc., to complete the assembling of the lithium ion secondary battery 100 of the present embodiment. The process of sealing the case 50 and the process of disposing (pouring) the electrolytic solution may be performed according to the conventional method for manufacturing a lithium ion secondary battery and do not characterize the present invention. The construction of the lithium ion secondary battery 100 according to the present embodiment is thus completed.

Several test examples relating to the present invention will be explained hereinbelow, but the present invention is not intended to be limited by the test examples.

<Fabrication of Lithium Ion Secondary Batteries (Sample Batteries for Evaluation)>

Initially, ternary positive electrode active materials (NCM lithium composite oxides) that differed in the Ni content from each other were fabricated. Thus, a total of 11 types of NCM lithium composite oxides in which the Ni content (mol %) with respect to the total of Ni, Co, and Mn was changed within a range of 30 mol % to 50 mol % were fabricated. The specific fabrication procedure is described hereinbelow.

The inside of a reaction vessel including water heated to 40° C. was purged with nitrogen, and a basic aqueous solution was then prepared by adding the appropriate amounts of 3.25% aqueous solution of sodium hydroxide and 25% ammonia water under a nitrogen flow and adjusting the pH at a liquid temperature of 25° C. to 12.0 and a liquid-phase ammonia concentration to 20 g/L.

A NCM aqueous solution was then prepared by adjusting the mixing ratio of a nickel salt (NiSO₄ in this case), a cobalt salt (CoSO₄ in this case), and a manganese salt (MnSO₄ in this case) such that the predetermined molar ratios of Ni, Co, and Mn are obtained (thus, such that the Ni content was within a range of 30 mol % to 50 mol %, and the molar contents of Co and Mn were equal to each other), and then dissolving the mixture in water. A NCM composite hydroxide was then precipitated by adding the NCM aqueous solution to the basic aqueous solution, while maintaining the pH at 12, and mixing. The target NCM composite hydroxide was obtained by filtering the precipitate, washing the alkali component, and drying. Lithium carbonate (Li₂CO₃) was then weighed such that the molar ratio (Li/T) of lithium to the total T number of moles of all of the transition metal elements (Ni, Co, Mn) in the NCM composite hydroxide was 1, tungsten oxide was then weighed such that the amount of tungsten (W) in the positive electrode active material was 0.8 mass %, and the weighed components were uniformly mixed with the heated hydroxide particles. W-including NCM lithium composite oxides of 11 types (see Tables 1 and 2) that differed from each other in the Ni content and had an average particle size of about 10 μm were then fabricated by calcining the obtained mixture for 4 hr at 760° C. in the air and then calcining for 10 hr at 950° C., grinding, and classifying.

The mass ratios of the positive electrode active material formed of the W-containing NCM lithium composite oxide obtained in the above-described manner, an electrically conductive material (carbon black), and a binder (PVDF) were adjusted to positive electrode active material:electrically conductive material:binder=90:8:2. A composition (positive electrode mix) for forming the positive electrode active material layer was prepared by mixing the positive electrode active material, electrically conductive material, and binder with N-methyl pyrrolidone (NMP). The positive electrode mix was then coated on both surfaces of a positive electrode collector (aluminum foil with a thickness of 15 μm), dried, and pressed to fabricate a positive electrode (positive electrode sheet) in which the positive electrode active material layer was formed at about 25 mg/cm² per unit surface area on both surfaces of the positive electrode collector.

Meanwhile, a graphite material and pitch were prepared, and acetylene black (AB) with an average particle size of 100 nm or less was prepared as a carbon black (CB).

A precalculated amount of AB and an appropriate amount of pitch were then added to the prepared graphite material such as to obtain an AB content of 0 mass % to 10 mass % as a whole per 100 g of the prepared graphite material and they were mixed to obtain samples (or a sample obtained without adding the AB). The samples were calcined in a high-temperature range of 500° C. or higher (500° C. (inclusive) to 800° C. (inclusive)), ground, and classified to prepare carbon-black-adhered (or not adhered) carbon-based negative electrode active materials of 10 types (see Tables 1 and 2) with an average particle size of about 10 μm that differed from each other in the content of CB (in this case, AB).

The mass ratios of the carbon-based negative electrode active material obtained in the above-described manner, a styrene-butadiene rubber (SBR) as a binder, and carboxymethyl cellulose (CMC) as a thickening agent were set to negative electrode active material:binder:thickening agent=98:1:1. The components were dispersed in water to prepare a composition (negative electrode mix) for forming a negative electrode active material layer. The negative electrode mix was then coated on both surfaces of a negative electrode collector (copper foil with a thickness of 10 μm), dried, and pressed to fabricate a negative electrode (negative electrode sheet) in which the negative electrode active material layer was formed at about 17 mg/cm² per unit surface area on both surfaces of a negative electrode collector.

A flat wound electrode body was fabricated by laminating the obtained positive electrode sheet and negative electrode sheet, with two separator sheets (a sheet of a three-layer structure including polypropylene (PP)/polyethylene (PE)/polypropylene (PP) and having a thickness of 20 μm and a pore size of 0.1 μm was used) being interposed therebetween, winding the laminate, and pressing and crushing the wound body from the side surface direction.

The wound electrode body was housed together with a nonaqueous electrolytic solution in a box-shaped battery case, and the opening in the battery case was air-tightly closed. As the nonaqueous electrolytic solution, the one prepared by including LiPF₆ as a support salt at a concentration of about 1 mol/L in a mixed solvent including EC, DMC, and EMC at a volume ratio of 3:4:3 was used.

Sample batteries (lithium ion secondary batteries) for evaluation were obtained by performing, by the usual method, the initial charge-discharge treatment (conditioning) of the lithium ion secondary batteries constructed in the above-described manner.

<Evaluation of Low-Temperature Characteristic (Capacity Retention Ratio)>

A predetermined number (300 cycles in this case) of predetermined charge-discharge cycles were performed under a temperature environment of −10° C. and the capacity retention ratio of each sample battery after the cycles was measured.

Initially, each sample battery was adjusted to a SOC of 60%. Charging for 10 sec at a constant current of 25 C, a rest interval of 10 min, discharging for 10 sec at a constant current of 25 C, and a rest interval of 10 min was taken as one cycle. A total of 300 such charge-discharge cycles were performed, while adjusting the sample battery to a SOC of 60% for every 50 cycles. The capacity retention ratio (%) was determined by the following formula.

Capacity retention ratio(%)=[(Battery capacity after charge-discharge cycle test)/(Initial battery capacity)×100

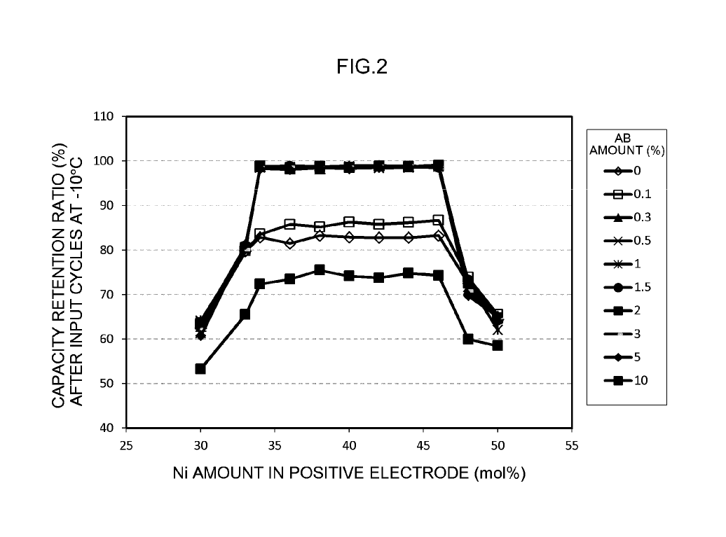

The results are shown in Table 1 and FIG. 2.

TABLE 1

| AB | Amount of Ni in positive electrode (%) | | | | | | | | | | |
|---|---|---|---|---|---|---|---|---|---|---|---|
| amount (%) | 30 | 33 | 34 | 36 | 38 | 40 | 42 | 44 | 46 | 48 | 50 |
| 0 | 62.5 | 79.8 | 82.9 | 81.5 | 83.3 | 82.9 | 82.8 | 82.8 | 83.3 | 72.6 | 64.4 |
| 0.1 | 63.3 | 79.9 | 83.6 | 85.8 | 85.2 | 86.3 | 85.8 | 86.2 | 86.7 | 73.9 | 65.5 |
| 0.3 | 62.9 | 80.5 | 98.7 | 98.8 | 98.3 | 98.9 | 99 | 98.7 | 99.1 | 71.2 | 65.2 |
| 0.5 | 61.5 | 80.7 | 98.9 | 98.5 | 98.5 | 98.9 | 98.8 | 98.6 | 98.8 | 71.8 | 64.7 |
| 1 | 64.2 | 80.2 | 98.6 | 98.7 | 98.7 | 98.9 | 98.5 | 98.6 | 99.2 | 72.8 | 62.1 |
| 1.5 | 63.6 | 81 | 98.7 | 98.9 | 98.8 | 98.4 | 98.7 | 98.9 | 98.6 | 73.3 | 64.2 |
| 2 | 63.7 | 80.4 | 98.9 | 98.3 | 98.8 | 98.6 | 98.9 | 98.8 | 99 | 72.6 | 64.8 |
| 3 | 62.2 | 80.1 | 98.5 | 98.6 | 98.4 | 98.6 | 98.8 | 98.9 | 98.5 | 70.8 | 64.8 |
| 5 | 60.8 | 81.3 | 98.3 | 98.1 | 98.5 | 98.3 | 98.6 | 98.7 | 98.6 | 69.8 | 65.1 |
| 10 | 53.3 | 65.5 | 72.4 | 73.5 | 75.5 | 74.2 | 73.8 | 74.8 | 74.3 | 60 | 58.5 |

The results shown in Table 1 and FIG. 2 clearly indicate that the capacity retention ratio of the sample batteries that used the ternary positive electrode active material formed of the NCM lithium composite oxide with the Ni content from 34 mol % (inclusive) to 46 mol % (inclusive) was better than that of the sample batteries using the ternary positive electrode active material with the Ni content below or above this appropriate range.

Further, the sample batteries that used the carbon-black (AB in this case) adhered carbon-based negative electrode active material with the acetylene black content of 0.3 mass % (inclusive) to 5 mass % (inclusive) in addition to using the ternary positive electrode active material formed of the NCM lithium composite oxide with the Ni content from 34 mol % (inclusive) to 46 mol % (inclusive) demonstrated a remarkably high capacity retention ratio. Thus, the capacity retention ratio after the charge-discharge cycle test was 95% or higher. Those results indicate that a lithium ion secondary battery demonstrating a very good low-temperature characteristic (for example, a very high capacity retention ratio) can be provided by setting the Ni content in the ternary positive electrode active material formed of the NCM lithium composite oxide and the CB content in the carbon-black-adhered carbon-based negative electrode active material to the above-described ranges.

<Evaluation of High-Rate Characteristic (Resistance Increase Ratio)>

The resistance increase ratio after a high-rate charging cycle test was investigated with respect to each sample battery. More specifically, each sample battery was charged at a constant current of 1 C to a terminal voltage of 3.75 V under a temperature condition of 25° C. and then charged at a constant voltage to a total charging time of 120 min to adjust the SOC to 60%. Each sample battery was then alternately charged and discharged every 10 sec at a current value of ⅓ C, 1 C, 2 C, and 3 C under the same temperature condition, and a voltage after 10 sec from the discharge start was measured. The current value (X axis) and voltage value (Y axis) at this time were linearly regressed and the initial internal resistance value R1 (mΩ) of each sample battery was determined from the inclination thereof.

After each sample battery has been adjusted to a SOC of 60%, the batteries were charged for 10 sec at a constant current of 30 C, allowed to stay for 5 sec, discharged for 200 sec at a constant current of 3 C, and allowed to stay for 145 sec. This was taken as 1 cycle, and 4000 cycles were performed. The operation of readjusting the SOC of the sample batteries during the test to 60% was performed every 100 cycles.

After the end of the 4000 cycles, the internal resistance value R2 (mΩ) after low-temperature high-rate cycles under a temperature condition of 25° C. was determined by the same method as was used in measuring the initial internal resistance value R1. The R2/R1 ratio was taken as the resistance increase ratio.

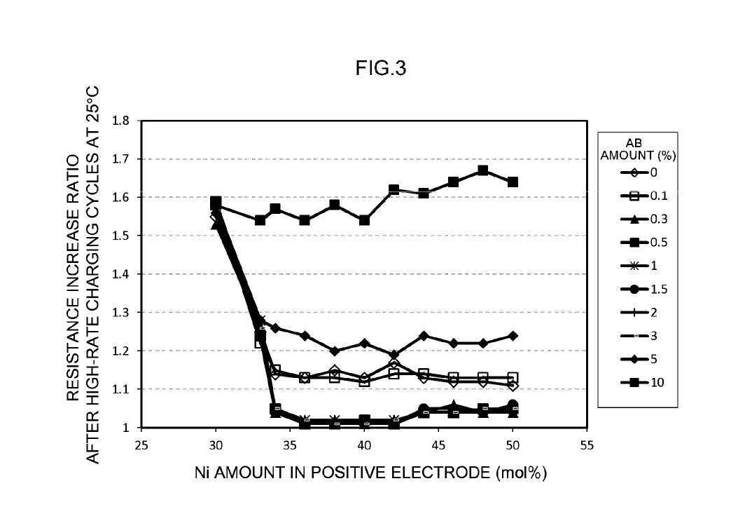

The results are shown in Table 2 and FIG. 3.

TABLE 2

| AB | Amount of Ni in positive electrode (%) | | | | | | | | | | |
|---|---|---|---|---|---|---|---|---|---|---|---|
| amount (%) | 30 | 33 | 34 | 36 | 38 | 40 | 42 | 44 | 46 | 48 | 50 |
| 0 | 1.55 | 1.25 | 1.14 | 1.13 | 1.15 | 1.13 | 1.17 | 1.13 | 1.12 | 1.12 | 1.11 |
| 0.1 | 1.58 | 1.22 | 1.15 | 1.13 | 1.13 | 1.12 | 1.14 | 1.14 | 1.13 | 1.13 | 1.13 |
| 0.3 | 1.53 | 1.26 | 1.04 | 1.02 | 1.02 | 1.01 | 1.02 | 1.04 | 1.06 | 1.04 | 1.04 |
| 0.5 | 1.59 | 1.24 | 1.05 | 1.01 | 1.01 | 1.02 | 1.01 | 1.04 | 1.04 | 1.05 | 1.05 |
| 1 | 1.58 | 1.28 | 1.04 | 1.02 | 1.02 | 1.01 | 1.02 | 1.04 | 1.04 | 1.05 | 1.04 |
| 1.5 | 1.59 | 1.25 | 1.04 | 1.01 | 1.01 | 1.01 | 1.01 | 1.05 | 1.05 | 1.04 | 1.06 |
| 2 | 1.59 | 1.23 | 1.04 | 1.01 | 1.02 | 1.02 | 1.02 | 1.04 | 1.04 | 1.04 | 1.05 |
| 3 | 1.57 | 1.26 | 1.05 | 1.02 | 1.01 | 1.01 | 1.02 | 1.04 | 1.04 | 1.05 | 1.05 |
| 5 | 1.56 | 1.28 | 1.26 | 1.24 | 1.2 | 1.22 | 1.19 | 1.24 | 1.22 | 1.22 | 1.24 |
| 10 | 1.58 | 1.54 | 1.57 | 1.54 | 1.58 | 1.54 | 1.62 | 1.61 | 1.64 | 1.67 | 1.64 |

The results shown in Table 2 and FIG. 3 clearly indicate that in sample batteries that used the ternary positive electrode active material formed of the NCM lithium composite oxide with the Ni content from 36 mol % (inclusive) to 42 mol % (inclusive) and also used the carbon-black (in this case AB) adhered carbon-based negative electrode active material with the acetylene black content of 0.3 mass % (inclusive) to 3 mass % (inclusive), the resistance increase rates after the 25° C. high-rate charging cycle test were confirmed to be very low. Therefore, by setting the Ni content in the ternary positive electrode active material formed of the NCM lithium composite oxide and the CB content in the carbon-black-adhered carbon-based negative electrode active material within the abovementioned ranges, it is possible to provide a lithium ion secondary battery that demonstrates an excellent high-rate characteristic in addition to the above-described good low-temperature characteristic (for example, capacity retention ratio).

The present invention is described hereinabove in detail, but the embodiments thereof are merely illustrative, and the invention disclosed herein is also inclusive of various changes and modifications of the above-described specific examples. Since the lithium ion secondary battery disclosed herein demonstrates the above-described excellent low-temperature characteristic, it can be advantageously used as a drive power source for a motor (electric motor) installed on a vehicle such as an automobile.

What is claimed is:

1. A lithium ion secondary battery comprising a positive electrode, a negative electrode, and a nonaqueous electrolytic solution,
the positive electrode including a ternary positive electrode active material formed of a lithium transition metal composite oxide having at least nickel (Ni), cobalt (Co), and manganese (Mn), and
the negative electrode including a carbon-black-adhered carbon-based negative electrode active material which is formed of a carbon material having a graphite structure in at least part thereof and which has carbon black (CB) that has adhered to at least part of a surface portion, wherein
a molar ratio x of nickel (Ni) calculated by taking a total molar amount of nickel (Ni), cobalt (Co), and manganese (Mn) in the ternary positive electrode active material as 100 satisfies the following condition:
34≦x≦46, and
a mass ratio α of carbon black (CB) calculated by taking a total mass of the carbon material and carbon black in the carbon-black-adhered carbon-based negative electrode active material as 100 satisfies the following condition:
0.3≦α≦5.

2. The lithium ion secondary battery according to claim 1, wherein
the molar ratio x of nickel (Ni) calculated by taking a total molar amount of nickel (Ni), cobalt (Co), and manganese (Mn) in the ternary positive electrode active material as 100 satisfies the following condition:
36≦x≦42, and
the mass ratio a of carbon black (CB) calculated by taking a total mass of the carbon material and carbon black in the carbon-black-adhered carbon-based negative electrode active material as 100 satisfies the following condition:
0.3≦α≦3.

3. The lithium ion secondary battery according to claim 1, wherein
the lithium transition metal composite oxide is a compound represented by the following formula:
Li₁₊ₐ(NiₓCo_{y}Mn_{z})_{1-γ}M_{γ}O₂
(where 0≦a≦0.14, x+y+z=1, 0.34≦x≦0.46, 0.99≦y/z≦1.01, 0≦γ≦0.05, and M is at least one element selected from the group consisting of Zr, W, Nb, Mg, Ca, Na, Fe, Cr, Zn, Si, Sn, Al, B, and F).

4. The lithium ion secondary battery according to claim 2, wherein
the lithium transition metal composite oxide is a compound represented by the following formula:
Li₁₊ₐ(NiₓCo_{y}M_{z})_{1-γ}M_{γ}O₂
(where 0≦a≦0.14, x+y+z=1, 0.34≦x≦0.46, 0.99≦y/z≦1.01, 0≦γ≦0.05, and M is at least one element selected from the group consisting of Zr, W, Nb, Mg, Ca, Na, Fe, Cr, Zn, Si, Sn, Al, B, and F).
